(19) United States
(12) Patent Application Publication
(10) Pub. No.: US 2026/0050475 A1
(43) Pub. Date: Feb. 19, 2026

(54) HARDWARE-OPTIMIZED MATRIX MULTIPLICATION OPERATIONS FOR LARGE LANGUAGE MODELS

(71) Applicant: XILINX, INC., San Jose, CA (US)

(72) Inventors: Rajeev Patwari, San Jose, CA (US); Abid Karumannil, Kerala (IN); Ashish Sirasao, San Jose, CA (US); Elliott Delaye, San Jose, CA (US); Jorn Tuyls, Antwerp (BE); Tejus Siddagangaiah, Broomfield, CO (US)

(21) Appl. No.: 18/805,198

(22) Filed: Aug. 14, 2024

(51) Int. Cl. G06F 9/50; G06F 17/16

(52) U.S. Cl. CPC G06F 9/5027; G06F 17/16

(57) ABSTRACT

A processing system configured to implement a large language model (LLM) includes an accelerator unit (AU) having hardware configured to perform matrix multiplication operations for the LLM using sets of predetermined matrix dimensions. Further, to help optimize the LLM for the processing system, the processing system includes a processor that modifies one or more matrix multiplication operations of the LLM based the sets of predetermined matrix dimensions supported by the hardware of the AU. The processor then recompiles the LLM using the modified multiplication operations and implements the recompiled LLM.

### BACKGROUND

Some processing systems are configured to execute applications requiring one or more large language models (LLM) to be implemented. These LLMs, for example, include layers of neural networks together configured to generate words, phrases, sentences, paragraphs, and the like based on one or more prompts provided by a user. To help implement the LLMs, these processing systems include processors configured to perform various matrix multiplication operations for the layers of the LLMs. However, due to the number of matrix multiplication operations required for the LLMs, performing these matrix multiplication operations drastically increases the overhead of the processor, preventing the processor from performing operations for other applications.

### BRIEF DESCRIPTION OF THE DRAWINGS

The present disclosure may be better understood, and its numerous features and advantages are made apparent to those skilled in the art by referencing the accompanying drawings. The use of the same reference symbols in different drawings indicates similar or identical items.

FIG. 1 is a block diagram of a processing system including an accelerator unit (AU) configured for hardware-based optimization of large language models (LLMs), in accordance with some implementations.

FIG. 2 is a block diagram of an example processor configured to generate one or more hardware-optimized LLMs, in accordance with some implementations.

FIG. 3 is a block diagram of an example set of matrices used in a matrix multiplication operation, in accordance with some implementations.

FIG. 4 is a block diagram of an example processing device configured to generate an accelerated LLM, in accordance with some implementations.

FIG. 5 is a flow diagram of an example method for modifying an LLM to produce an accelerated LLM based on one or more hardware parameters, in accordance with implementations.

FIG. 6 is a flow diagram of an example method for modifying an LLM to produce a hardware-optimized LLM based on greatest common divisors, in accordance with implementations.

FIG. 7 is a flow diagram of an example method for modifying an LLM to produce a hardware-optimized LLM based on hardware-supported matrix dimensions, in accordance with implementations.

### DETAILED DESCRIPTION

Systems and techniques disclosed herein include a processing system configured to implement one or more large language models (LLMs). For example, some applications, when executed by a processing system, implement one or more LLMs so as to generate words, sentences, paragraphs, phrases, and the like. To this end, these LLMs require matrix multiplication operations to be performed so as to generate tokens used during the prefill and decoding phases of the LLMs. Within the LLMs, such matrix multiplication operations (e.g., MatMul primitives) are each compiled so as to perform matrix multiplication (e.g., determine the dot product) of a first matrix having a first set of dimensions by a second matrix having a second set of dimensions to produce a third matrix having a third set of dimensions. Such dimensions, for example, define the number of rows of a matrix and the number of columns of a matrix. As an example, a matrix operation of an LLM is compiled so as to perform matrix multiplication on a first matrix having a first number of rows and a first number of columns by a second matrix having a second number of rows (e.g., equal to the first number of columns) and a second number of columns to as to produce a third matrix having the first number of rows and the second number of columns.

To help perform the matrix multiplication operations for the LLMs, the processing system includes an acceleration unit (AU). The AU includes a matrix multiplication circuitry which includes hardware configured to perform matrix multiplication operations using matrices that have predetermined dimensions (e.g., predetermined numbers of rows and set numbers of columns). However, some LLMs implemented by the applications of the processing system include matrix multiplication operations having matrices with dimensions that are unable to be performed by the matrix multiplication circuitry of the AU. For example, some LLMS include matrix multiplication operations that define matrix dimensions that are incompatible with the set of predetermined matrix dimensions supported by the matrix multiplication circuitry of the AU. To this end, the processing system also includes a central processing unit (CPU) that includes processor cores configured to perform matrix multiplication operations with matrices of any dimensions. However, having the CPU perform such matrix multiplication operations increases the overhead of the CPU, reducing the ability of the CPU to perform other operations and lowering the processing efficiency of the processing system.

As such, systems and techniques disclosed herein are directed to hardware-aware optimization and acceleration of LLMs. For example, to help reduce the overhead of the CPU, the processing system is configured to implement one or more LLMs that have been optimized based on the matrix multiplication circuitry of the AU. To this end, the CPU is configured to have access to one or more accelerated LLMs. Such accelerated LLMs, for example, include LLMs having matrix multiplication operations using matrices having matrix dimensions compatible with one or more different types of hardware (e.g. AUs, accelerators). To produce these accelerated LLMs, as an example, a processing device within or otherwise connected to the processing system is configured to first initialize an LLM and insert one or more observers into the LLMs. These observers, for example, are configured to track the statistics of one or more tensors in the LLMs while the LLM is executed. As an example, the observers track the statistics (e.g., inputs, outputs) of multiplication operations (e.g., MatMuls) of the LLM. The processing device then runs the LLM while the observers of the LLM collect tensor statistics of the LLM. Based on the tensor statistics, the processing device determines the dimensions of the matrices used during the matrix multiplication operations of the prefill phases of the LLM and the decode phases of the LLM. As an example, the processing device determines the dimensions of the matrices used during the matrix multiplication operations of the prefill phase of each layer of the LLM and the dimensions of the matrices used during the matrix multiplication operations of the decode phases of each layer of the LLM. The processing device then modifies the determined matrix dimensions used during the matrix multiplication operations of the prefill phases of the LLM and the decode phases of the LLM based on one or more hardware parameters. Such hardware parameters, for example, represent the set matrix dimensions of matrix multiplication operations supported by one or more types of hardware (e.g., certain AUs, accelerators). For example, the processing device modifies the determined matrix dimensions used during the matrix multiplication operations of the prefill phases of the LLM and the decode phases of the LLM so as to match one or more supported matrix dimensions of the hardware represented by the hardware parameters. After determining these modified matrix dimensions, the processing device modifies the matrix operations of the LLM based on the modified matrix dimensions and recompiles the LLM with the modified matrix operations to produce an accelerated LLM. The processing device then stores the accelerated LLM in a memory, transmits (e.g., via a network) the accelerated LLM, or both such that the accelerated LLM is available to the processing system.

The implement an LLM for an application, the CPU selects an available accelerated LLM associated with the LLM. For example, the CPU selects the accelerated LLM generated from the LLM for the application. Because the accelerated LLM includes matrix multiplication operations that have matrix operations matching hardware parameters of certain hardware, the likelihood of the matrix multiplication circuitry of the AU being able to perform matrix multiplication operations for the accelerated LLM is increased. However, when the matrix operations of the accelerated LLM are modified based on hardware parameters representing hardware different from the AU of the processing system, there is still a likelihood that the matrix multiplication circuitry of the AU cannot perform some matrix multiplication operations of the accelerated LLM. As such, the processing system is further configured to modify the matrix multiplication operations of the accelerated LLM based on the sets of predetermined matrix dimensions supported by the matrix multiplication circuitry of the AU. For example, after an accelerated LLM is made available to the processing system, the CPU of the processing first compares the matrix dimensions of the matrix multiplication operations of the accelerated LLM to the sets of predetermined matrix dimensions supported by the matrix multiplication circuitry of the AU. Based on the comparison, the CPU then determines one or more hardware-based matrix dimensions for the matrix multiplication operations of the accelerated LLM.

As an example, the CPU first selects sets of predetermined matrix dimensions supported by the matrix multiplication circuitry closest in value to the common greatest divisors of the dimensions of the matrices used in the prefill and decode phases, respectively, of all layers of the accelerated LLM. The CPU then modifies the matrix dimensions of the matrix operations of the prefill and decode phases of the layers of the accelerated LLM such that the matrix dimensions of the matrix operations are multiples of a respective selected set of predetermined matrix dimensions supported by the matrix multiplication circuitry. As another example, for each layer of the accelerated LLM, the CPU selects sets of predetermined matrix dimensions supported by the matrix multiplication circuitry that are closest in value to the matrices used in the prefill and decode phases of the layer, respectively. The CPU then modifies the matrix dimensions of the matrix operations of the prefill and decode phases of the layer of the accelerated LLM such that the matrix multiplication operations of the layer include matrix dimensions equal to a corresponding set of selected predetermined matrix dimensions supported by the matrix multiplication circuitry. The CPU then recompiles the accelerated LLM with the modified matrix multiplication operations to produce a hardware-optimized LLM which the CPU then implements for one or more applications. In this way, the CPU modifies the matrix dimensions of the matrix operations of an LLM so that the matrix multiplication operations are able to be performed on the matrix multiplication circuitry of the AU, helping decrease the number of matrix operations performed by the CPU. Because the CPU performs fewer matrix multiplication operations, the overhead of the CPU is reduced, allowing the CPU to perform other operations and increasing the processing efficiency of the processing system.

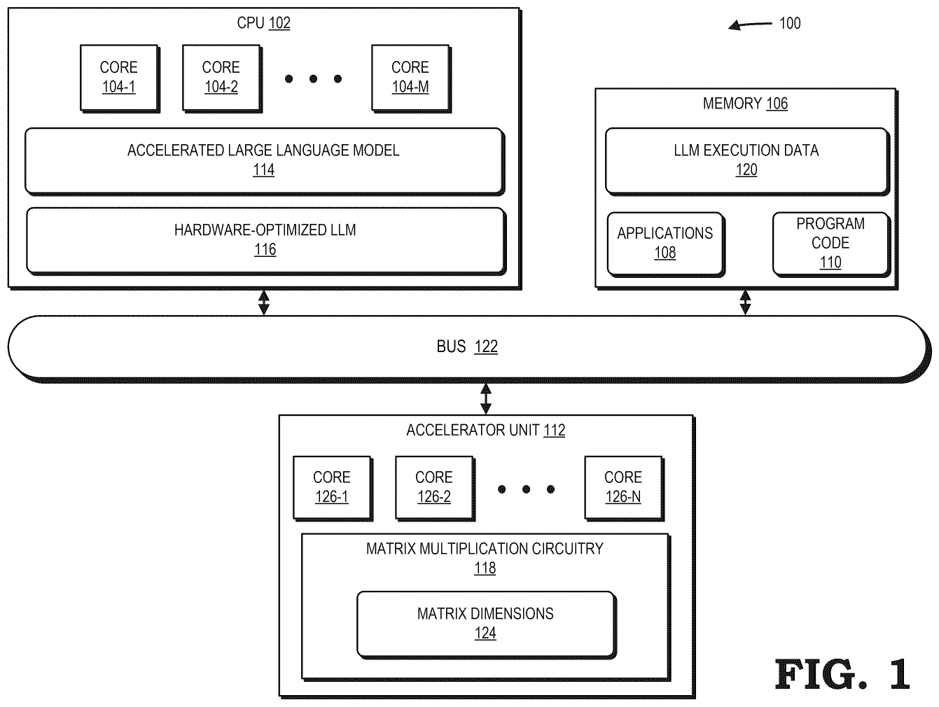

Referring now to FIG. 1, a processing system 100 including an AU configured for hardware-based optimization of LLMs is presented, in accordance with some implementations. In implementations, processing system 100 is implemented within one or more servers, databases, cloud-based devices, personal computers, laptops, drones, mobile devices, or the like and includes or has access to memory 106 or other storage components implemented using a non-transitory computer-readable medium, for example, a dynamic random-access memory (DRAM). In some implementations, memory 106 is implemented using other types of memory including, for example, static random-access memory (SRAM), nonvolatile RAM, and the like. Further, memory 106, according to some implementations, includes an external memory implemented external to the processing units implemented in the processing system 100. The processing system 100 also includes a bus 122 to support communication between components (e.g., CPU 102, AU 112, memory 106) implemented in the processing system 100. Some implementations of processing system 100 include other buses, bridges, switches, routers, and the like, which are not shown in FIG. 1 in the interest of clarity. For example, in some implementations, processing system 100 includes a data fabric including bus 122 and configured to support communication between the components of processing system 100.

According to implementations, processing system 100 is configured to execute one or more applications 108 such as compute applications, graphics applications, machine-learning applications, neural network applications, artificial intelligence applications, or any combination thereof, to name a few. In implementations, some applications 108 when executed by processing system 100, cause processing system 100 to implement one or more LLMs. Such LLMs, for example, include neural networks configured to generate one or more words, sentences, phrases, and the like based on one or more inputs (e.g., prompts). To this end, an LLM has one or more interconnected layers each having a respective set of parameters (e.g., weights). Further, each layer of the LLM includes a prefill phase and a decoding stage. During a prefill stage, a layer of the LLM receives an input (e.g., prompt) and generates a key-value cache that includes one or more keys (e.g., descriptions of content) and one or more values (e.g., content matching inputs). After the prefill stage, the layer of the LLM includes a decoding stage. During the decoding stage and using the key-value cache, the layer of the LLM generates a first token (e.g., word, portion of a sentence) based on the input. The layer of the LLM then generates a second token by using the first token as input. The layer of the LLM then continues to generate tokens one at a time by using a previous token as an input during the decoding stage until a final result is reached. In implementations, such LLMS implemented by processing system 100 include, for example, LLaMA, LLaMA2, Alpaca, Vicuna, Guanaco, RedPajama, Falcon, FLAN-T5, MPT, and the like.

To help generate the key-value cache during the prefill stage of a layer of an LLM, the processing system 100 is configured to perform one or more matrix multiplication operations (e.g., MatMul primitives) based on the size of the input. That is to say, the processing system 100 is configured to perform one or more matrix multiplication operations on matrices having dimensions based on the length of the prompt. As an example, the processing system 100 is configured to perform matrix multiplication operations that include multiplying a first matrix by a second matrix to produce a third matrix. Such a first matrix, for example includes a first number of rows based on the length of the prompt and a number of columns based on the parameters of the LLM. Additionally, the second matrix, for example, includes a second number of rows equal to the first number of columns of the first matrix and a second number of columns based on the parameters of the LLM. The resulting third matrix then includes the first number of rows and the second number of columns. Further, during the decoding stage of a layer of an LLM, the processing system 100 is configured to perform additional multiplication operations that include multiplying a first matrix by a second matrix to produce a third that each has similar dimensions as the matrices used during the prefill phase. However, because only one token is generated at a time during the decoding stage, the first matrix used during the matrix multiplication operations of the decoding stage includes a single row rather than a number of rows based on the length of the prompt as in the prefill stage.

According to implementations, to perform these matrix multiplication operations, the processing system 100 includes AU 112. AU 112, for example, is configured to operate as one or more vector processors, coprocessors, graphics processing units (GPUs), general-purpose GPUs (GPGPUs), non-scalar processors, highly parallel processors, artificial intelligence (AI) processors, inference engines, machine-learning processors, other multithreaded processing units, scalar processors, serial processors, programmable logic devices (e.g., field-programmable logic devices (FPGAs)), or any combination thereof. In implementations, AU 112 performs one or more commands, instructions, draw calls, or any combination thereof indicated in an application 108. For example, for certain applications 108, AU 112 performs one or more commands, instructions, or both so as to generate one or more results for one or more computations. As another example, for graphics applications, AU 112 performs one or more commands, instructions, draw calls, or any combination thereof so as to render images according to one or more graphics applications for presentation on display. To perform commands, instructions, draw calls, or any combination thereof for one or more applications 108, AU 112 implements a plurality of processor cores 126-1 to 126-N that execute instructions concurrently or in parallel. In some implementations, one or more of the processor cores 126 each operate as one or more compute units (e.g., SIMD units) that perform the same operation on different data sets. Though in the example implementation illustrated in FIG. 1, AU 112 includes three processor cores (126-1, 126-2, 126-N) representing an N number of cores, the number of processor cores 126 implemented in AU 112 is a matter of design choice. As such, in other implementations, AU 112 can include any number of processor cores 126. The processor cores 104 execute instructions such as program code 110 (e.g., machine-learning code, neural network code) stored in memory 106, and AU 112 stores data in memory 106 such as the results of the executed instructions.

To perform matrix multiplication operations for one or more LLMs, AU 112 includes matrix multiplication circuitry 118. Matrix multiplication circuitry 118, for example, includes hardware configured to perform matrix multiplication using matrices each having a respective set of dimensions supported by matrix multiplication circuitry 118 (e.g., hardware configured to perform matrix multiplication using sets of predetermined matrix dimensions). As an example, matrix multiplication circuitry 118 includes fixed-function hardware configured to perform matrix multiplication operations that include multiplying a first matrix having a set first number of rows and a set first number of columns by a second matrix having a set second number of rows (e.g., equal to the set first number of columns) and a set second number of columns to produce a third matrix having the set first number of rows and set second number of columns. In implementations, matrix multiplication circuitry 118 includes multiple sets of supported predetermined dimensions for each of the first, second, and third matrices used in a matrix multiplication operation. However, some LLMs require matrix multiplication operations to be performed with matrices that have dimensions not compatible with the sets of predetermined matrix dimensions supported by matrix multiplication circuitry 118.

To this end, in implementations, CPU 102 of processing system 100 is configured to perform these matrix multiplication operations. For example, in implementations, CPU 102 is connected to the bus 122 and therefore communicates with AU 112 and the memory 106 via the bus 122. To perform matrix multiplication operations for an LLM implemented by an application 108, CPU 102 implements a plurality of processor cores 104-1 to 104-M that execute instructions concurrently or in parallel. In implementations, one or more of the processor cores 104 operate as SIMD units that perform the same operation on different data sets. Though in the example implementation illustrated in FIG. 1, three processor cores (104-1, 104-2, 104-M) are presented representing an M number of cores, the number of processor cores 104 implemented in the CPU 102 is a matter of design choice. As such, in other implementations, the CPU 102 can include any number of processor cores 104. The processor cores 104 executes instructions such as program code 110 for one or more applications 108 stored in the memory 106 and the CPU 102 stores information in the memory 106 such as the results of the executed instructions. However, using CPU 102 to perform matrix multiplication operations for an LLM implemented by an application 108 increases the overhead of CPU 102, diminishing the ability of CPU 102 to perform operations for the same or other applications 108 and lowering the processing efficiency of the processing system 100.

As such, to help decrease the overhead of CPU 102, processing system 100 is configured to implement one or more accelerated LLMs 114. These accelerated LLMs 114, for example, represent accelerated versions of one or more LLMs to be implemented for one or more applications 108 executed by processing system 100. As an example, in implementations, a processing device (not pictured for clarity) included in or otherwise connected to processing system 100 is configured to generate an accelerated LLM 114 based on an initial LLM and a set of hardware parameters representing one or more certain AUs, processing systems, fixed function hardware, and the like. To this end, the processing device first initializes the initial LLM and inserts one or more observers into the initial LLM. These observers, for example, are configured to track the statistics of one or more tensors in the initial LLM while the LLM is executed. As an example, the observers track the statistics (e.g., inputs, outputs) of matrix multiplication operations (e.g., MatMul primitives) of the LLM. The processing device then runs the LLM while the observers of the LLM collect tensor statistics of the LLM. Based on the tensor statistics, the processing device determines the dimensions of the matrices used during the matrix multiplication operations of the prefill phases of the LLM and the decode phases of the LLM. For example, based on the collected tensor statistics, the processing device extracts the weights (e.g., weight shapes) applied to the parameters of the LLM. Using the extracted weight shapes, the processing device then runs one or more inferences (e.g., trained machine-learning models) configured to determine the dimensions of the matrices used in both the prefill stages and decoding stages of each layer of the initial LLM.

Further, based on the dimensions of the matrices used in both the prefill stages and decoding stages of each layer of the initial LLM, the processing device selects sets of predetermined matrix dimensions supported by hardware (e.g., AUs, processing systems, fixed-function hardware) represented by the hardware parameters. As an example, the processing device selects a set of matrix dimensions supported by the hardware represented by the hardware parameters that are closest in value yet still greater than the determined dimensions of the matrices used in both the prefill stages and decoding stages of each layer of the initial LLM. The processing device then modifies the matrix multiplication operations of the initial LLM based on the selected set of matrix dimensions supported by the hardware represented by the hardware parameters to produce an accelerated LLM 114. As an example, the processing device pads (e.g., adds one or more set values) to matrices used in the matrix multiplication operations of the initial LLM such that the matrices used in the matrix multiplication operations of the initial LLM have dimensions equal to the selected set of matrix dimensions supported by the hardware represented by the hardware parameters. The processing device then provides the accelerated LLM 114 and LLM execution data 120 to the processing system 100 via, for example, a network (e.g., local area network, internet, data fabric network). Such LLM execution data 120, for example, includes data representing the matrix dimensions used in the matrix multiplication operations during the prefill and decoding phases of each layer of an accelerated LLM 114. In this way, the processing device generates accelerated LLMs 114 that include matrix multiplication operations having matrix dimensions based on one or more hardware parameters. Because the matrix dimensions of the matrix multiplication operations of the accelerated LLMs 114 are based on such hardware parameters, the likelihood that the matrix multiplication operations are able to be performed on AU 112 is increased, helping to decrease the overhead of CPU 102 and increase the processing efficiency of processing system 100.

However, when the hardware represented by the hardware parameters used to generate the accelerated LLMs 114 supports matrix multiplication operations that use matrices with matrix dimensions that differ from the matrix dimensions supported by AU 112 (e.g., matrix multiplication circuitry 118), the likelihood that AU 112 cannot perform one or more matrix multiplication operations of an accelerated LLM 114 are increased. As such, CPU 102 is configured to modify an accelerated LLM 114 based on matrix multiplication circuitry 118 so as to produce a hardware-optimized LLM 116. That is to say, CPU 102 modifies an accelerated LLM 114 based on the sets of predetermined matrix dimensions supported by matrix multiplication circuitry 118 so as to produce a hardware-optimized LLM 116. To this end, in implementations, CPU 102 selects a set of predetermined matrix dimensions supported by matrix multiplication circuitry 118 based on dimensions of one or more matrices used in one or more matrix multiplication operations of the accelerated LLM 114. As an example, in some implementations, CPU 102 first determines the matrix dimensions of the matrices used in the matrix multiplication operations of the prefill and decoding phases of each layer of an accelerated LLM 114 based on LLM execution data 120 associated with the accelerated LLM 114. CPU 102 then selects respective sets of predetermined matrix dimensions supported by matrix multiplication circuitry 118 that are closest in size to the greatest common divisors of the matrix dimensions of the matrices used in the matrix multiplication operations of the prefill phase of each layer of an accelerated LLM 114 and that are closest in size to the greatest common divisors of the matrix dimensions of the matrices used in the matrix multiplication operations of the decoding phase of each layer of an accelerated LLM 114. After selecting these sets of predetermined matrix dimensions supported by matrix multiplication circuitry 118, CPU 102 then pads (e.g., adds one or more set values) to each matrix to be multiplied in the matrix multiplication operations of the prefill and decoding phases of each layer of the accelerated LLM 114 such that the dimensions of the matrices are multiples of the dimensions in a corresponding selected set of matrix dimensions. CPU 102 then recompiles the accelerated LLM 114 with the padded matrices to generate a hardware-optimized LLM 116.

As another example, in some implementations, CPU 102 first determines the matrix dimensions of the matrices used in the matrix multiplication operations of the prefill and decoding phases of each layer of an accelerated LLM 114 based on LLM execution data 120 associated with the accelerated LLM 114. For each layer of the accelerated LLM 114, CPU 102 then selects respective sets of predetermined matrix dimensions supported by matrix multiplication circuitry 118 that are closest in size to the matrix dimensions of the matrices used in the matrix multiplication operations of the prefill phase of the layer and 118 that are closest in size to the matrix dimensions of the matrices used in the matrix multiplication operations of the decoding phase of the layer. After selecting respective sets of predetermined matrix dimensions supported by matrix multiplication circuitry 118 for a corresponding layer of the accelerated LLM 114, CPU 102 then pads (e.g., adds one or more set values to) each matrix to be multiplied in the prefill and decoding phases of the layer such that the dimensions of the matrices are multiples of a corresponding selected set of matrix dimensions supported by matrix multiplication circuitry 118. CPU 102 then recompiles the accelerated LLM 114 with the padded matrices to generate a hardware-optimized LLM 116. In this way, CPU 102 is configured to modify one or more LLMs (e.g., accelerated LLMs 114) such that the matrix multiplication operations of the LLMs are able to be performed on the matrix multiplication circuitry 118 of AU 112. Because the matrix multiplication operations of the LLMs are able to be performed on the matrix multiplication circuitry 118 of AU 112, AU 112, rather CPU 102, performs these matrix multiplication operations, reducing the overhead of CPU 102 and improving the processing efficiency of processing system 100.

After modifying an accelerated LLM 114 to produce a hardware-optimized LLM 116, CPU 102 stores the hardware-optimized LLM in, for example, memory 106. CPU 102 is then configured to implement the hardware-optimized LLM 116 each time an application 108 requires an LLM associated with the hardware-optimized LLM 116. As an example, based on an application 108 requiring a first LLM, CPU 102 implements the hardware-optimized LLM 116 generated from an accelerated LLM 114 associated with (e.g., generated from) the first LLM. As another example, based on an application 108 requiring a first LLM, CPU 102 implements a hardware-optimized LLM 116 generated from (e.g., modified from) the first LLM.

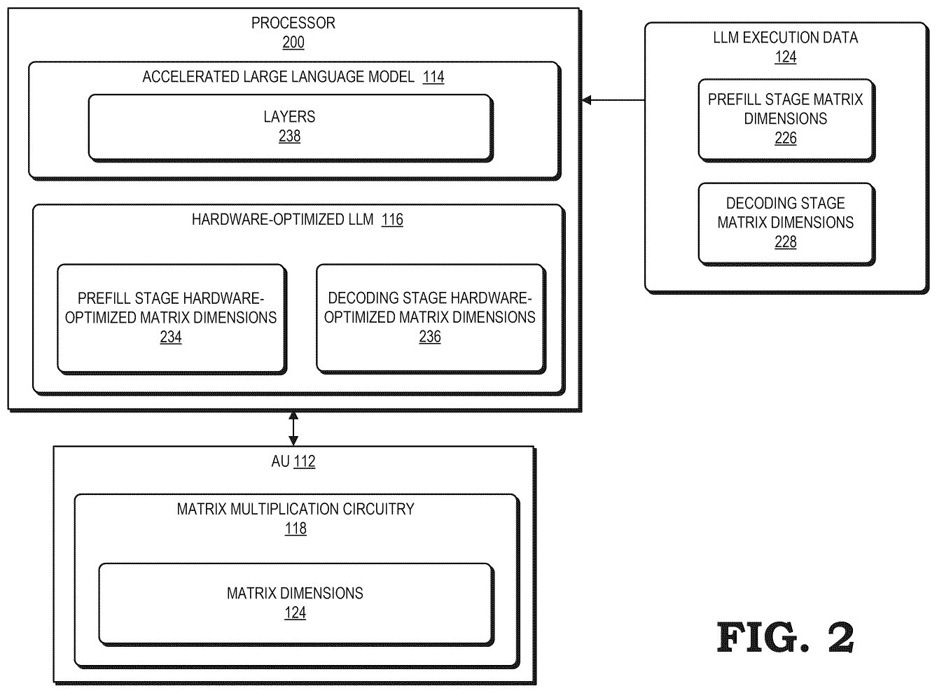

Referring now to FIG. 2, an example processor 200 configured to generate one or more hardware-optimized LLMs 116 is presented, in accordance with some implementations. In implementations, example processor 200 is implemented in processing system 100 as CPU 102. According to implementations, example processor 200 is configured to modify one or more LLMs based on matrix multiplication circuitry 118 so as to produce a hardware-optimized LLM 116 that includes matrix multiplication operations (e.g., MatMul primitives) able to be performed by matrix multiplication circuitry 118. That is to say, example processor 200 is configured to modify one or more LLMs based on the matrix dimensions 124 (e.g., dimensions of the matrices used in matrix multiplication operations) supported by matrix multiplication circuitry 118. To this end, in implementations, example processor 200 has access to one or more LLMs. As an example, example processor 200 has access to one or more accelerated large language models 114 stored, for example, in memory 106. According to implementations, each LLM (e.g., accelerated LLM 114) accessible by example CPU 102 includes one or more layers 238. Each layer 238, for example, includes one or more neural networks configured to generate one or more outputs based on one or more inputs and one or more parameters (e.g., weights). For example, each layer 238 includes a prefill stage configured to generate a key-value cache based on an input (e.g., prompt) and one or more parameters and a decoding stage configured to generate tokens one at a time based on previously generated tokens and one or more parameters. Further, in implementations, example processor 200 has access to LLM execution data 120 for one or more LLMs (e.g., accelerated LLMs 114) accessible by example processor 200. Such LLM execution data 120 includes the dimensions of the matrices used in the matrix multiplication operations of a corresponding LLM. As an example, LLM execution data 120 includes the dimensions of the first matrices, second matrices, and third (e.g., resulting) matrices for matrix multiplication operations during the prefill stages of each layer 238 of an LLM, represented in FIG. 2 as prefill stage matrix dimensions 226. Further, for example, LLM execution data 120 includes the dimensions of the first matrices, second matrices, and third (e.g., resulting) matrices for matrix multiplication operations during the decoding stages of each layer 238 of an LLM, represented in FIG. 2 as decoding stage matrix dimensions 228.

To modify an LLM (e.g., accelerated LLM 114) based on the predetermined matrix dimensions 124 supported by matrix multiplication circuitry 118, example processor 200 first determines the prefill stage matrix dimensions 226 and decoding stage matrix dimensions 228 of the LLM based on LLM execution data 120. That is to say, example processor 200 determines the dimensions of the matrices used in the matrix multiplication operations of the prefill stages of each layer of the LLM and the decoding stages of each layer of the LLM. Example processor 200 then modifies the prefill stage matrix dimensions 226 and decoding stage matrix dimensions 228 of the LLM based on the matrix dimensions 124 supported by matrix multiplication circuitry 118. As a first example, example processor 200 determines the greatest common divisors for the dimensions of the matrices used during the matrix multiplication operations of the prefill stages of all the layers of an LLM (e.g., prefill stage matrix dimensions 226) and the greatest common divisors for the dimensions of the matrices used during matrix multiplication operations of the decoding stages of all the layers of the LLM (e.g., decoding stage matrix dimensions 228). Such greatest common divisors, for example, represent the greatest set of matrix dimensions by which the dimensions of two or more matrices are able to be divided with no remainder. In implementations, for example, example processor 200 determines a first greatest common divisor for the dimensions of the first matrices (e.g., matrices on the left side of the operand) used during the matrix multiplication operations of the prefill stages of all the layers of an LLM, a second greatest common divisor for the dimensions of the second matrices (e.g., matrices on the right side of the operand) used during the matrix multiplication operations of the prefill stages of all the layers of an LLM, a third greatest common divisor for the dimensions of the third matrices (e.g., resulting matrices) used during the matrix multiplication operations of the prefill stages of all the layers of an LLM, a fourth greatest common divisor for the dimensions of the first used during the matrix multiplication operations of the decoding stages of all the layers of an LLM, a fifth greatest common divisor for the dimensions of the second matrices used during the matrix multiplication operations of the decoding stages of all the layers of an LLM, a sixth greatest common divisor for the dimensions of the third matrices used during the matrix multiplication operations of the decoding stages of all the layers of an LLM.

After determining the first, second, third, fourth, fifth, and sixth greatest common divisors, example processor 200 then determines a corresponding set of matrix dimensions 124 supported by matrix multiplication circuitry 118 that is closest in size to the first, second, third, fourth, fifth, and sixth greatest common divisors, respectively. For example, example processor 200 determines a first set matrix dimensions 124 closest in size, but greater than, the first greatest common divisor, a second set matrix dimensions 124 closest in size, but greater than, the second greatest common divisor, a third set matrix dimensions 124 closest in size, but greater than, the third greatest common divisor, a fourth set matrix dimensions 124 closest in size, but greater than, the fourth greatest common divisor, a fifth set matrix dimensions 124 closest in size, but greater than, the fifth greatest common divisor, and a sixth set matrix dimensions 124 closest in size, but greater than, the sixth greatest common divisor. Once example processor 200 has determined a corresponding set of matrix dimensions 124 for each greatest common divisor, example processor 200 modifies the dimensions of the first, second, and third matrices used during the matrix multiplication operations of the prefill stages and decoding stages of all the layers of an LLM such that each matrix has dimensions that are multiples of a corresponding set of matrix dimensions 124. For example, example processor 200 pads (e.g., adds set values of 0 to) the first matrices (e.g., matrices on the left of the operand) used during the matrix multiplication operations of the prefill stages of all the layers of an LLM such that the dimensions of the first matrices are multiples of the first set of matrix dimensions 124, pads the second matrices (e.g., matrices on the right of the operand) used during the matrix multiplication operations of the prefill stages of all the layers of an LLM such that the dimensions of the second matrices are multiples of the second set of matrix dimensions 124, pads the third matrices (e.g., resulting matrices) used during the matrix multiplication operations of the prefill stages of all the layers of an LLM such that the dimensions of the third matrices are multiples of the third set of matrix dimensions 124, pads the first matrices used during the matrix multiplication operations of the decoding stages of all the layers of an LLM such that the dimensions of the first matrices are multiples of the fourth set of matrix dimensions 124, pads the second matrices used during the matrix multiplication operations of the decoding stages of all the layers of an LLM such that the dimensions of the second matrices are multiples of the fifth set of matrix dimensions 124, and pads the third matrices used during the matrix multiplication operations of the decoding stages of all the layers of an LLM such that the dimensions of the third matrices are multiples of the sixth set of matrix dimensions 124.

After padding the dimensions of the matrices within the matrix multiplication operations of the prefill stages of all the layers 238 of the LLM, example processor 200 produces matrices having prefill stage hardware-optimized matrix dimensions 234. Due to these matrices having such prefill stage hardware-optimized matrix dimensions 234 based on matrix dimensions 124 supported by matrix multiplication circuitry 118, matrix multiplication circuitry 118 is able to perform matrix multiplication operations during the prefill stages of the layers 238 of the LLM that use such matrices. Likewise, after padding the dimensions of the matrices within the matrix multiplication operations of the decoding stages of all the layers 238 of the LLM, example processor 200 produces matrices having decoding stage hardware-optimized matrix dimensions 236. Due to these matrices having such decoding stage hardware-optimized matrix dimensions 236 based on matrix dimensions 124 supported by matrix multiplication circuitry 118, matrix multiplication circuitry 118 is able to perform matrix multiplication operations during the decoding stages of all the layers 238 of the LLM that use such matrices. Example processor 200 then recompiles the LLM with the padded matrices (e.g., matrices having prefill stage hardware-optimized matrix dimensions 234 or decoding stage hardware-optimized matrix dimensions 236) to produce a hardware-optimized LLM 116 and stores the hardware-optimized LLM 116, for example, in memory 106. Example processor 200 then implements the hardware-optimized LLM 116 each time the LLM used to generate the hardware-optimized LLM 116 is required by an application 108.

As a second example, to modify an LLM (e.g., accelerated LLM 114) based on the matrix dimensions 124 supported by matrix multiplication circuitry 118, example processor 200, for each layer 238 of an LLM, determines a corresponding set of matrix dimensions 124 supported by matrix multiplication circuitry 118 that is closest in size to the dimensions of the matrices used during matrix multiplication operations of a prefill stage and the dimensions of the matrices used during matrix multiplication operations of a decoding stage. For example, for each layer 238 of an LLM, example processor 200 determines a first set of matrix dimensions 124 closest in size, yet greater than, the dimensions of the first matrices (e.g., matrices on the left of the operand) used during the prefill stage, a second set of matrix dimensions 124 closest in size, yet greater than, the dimensions of the second matrices (e.g., matrices on the right of the operand) used during the prefill stage, a third set of matrix dimensions 124 closest in size, yet greater than, the dimensions of the third matrices (e.g., resulting matrices) used during the prefill stage, a fourth set of matrix dimensions 124 closest in size, yet greater than, the dimensions of the first matrices used during the decoding stage, a fifth set of matrix dimensions 124 closest in size, yet greater than, the dimensions of the second matrices used during the decoding stage, and a sixth set of matrix dimensions 124 closest in size, yet greater than, the dimensions of the third matrices used during the decoding stage.

After example processor 200 has determined a corresponding set of matrix dimensions 124 for each matrix used during the prefill stage and decoding stage of a layer 238, example processor 200 modifies the dimensions of the first, second, and third matrices used during the matrix multiplication operations of the prefill stages and decoding stages of the layer 238 such that each matrix has dimensions that are multiples of a corresponding set of matrix dimensions 124. For example, example processor 200 pads (e.g., adds set values of 0) the first matrices (e.g., matrices on the left of the operand) used during the matrix multiplication operations of the prefill stage of the layer 238 such that the dimensions of the first matrices are multiples of the first set of matrix dimensions 124, pads the second matrices (e.g., matrices on the right of the operand) used during the matrix multiplication operations of the prefill stage of the layer 238 such that the dimensions of the second matrices are multiples of the second set of matrix dimensions 124, pads the third matrices (e.g., resulting matrices) used during the matrix multiplication operations of the prefill stage the layer 238 such that the dimensions of the third matrices are multiples of the third set of matrix dimensions 124, pads the first matrices used during the matrix multiplication operations of the decoding stage of the layer 238 such that the dimensions of the first matrices are multiples of the fourth set of matrix dimensions 124, pads the second matrices used during the matrix multiplication operations of the decoding stage of the layer 238 such that the dimensions of the second matrices are multiples of the fifth set of matrix dimensions 124, and pads the third matrices used during the matrix multiplication operations of the decoding stage of the layer 238 such that the dimensions of the third matrices are multiples of the sixth set of matrix dimensions 124.

Once example processor 200 has modified the dimensions of the matrices within the matrix multiplication operations of the prefill stage for each layer 238 of the LLM, example processor 200 produces matrices for each layer 238 of the LLM that each have respective prefill stage hardware-optimized matrix dimensions 234 for their corresponding layer 238. Due to these matrices having such prefill stage hardware-optimized matrix dimensions 234 based on matrix dimensions 124 supported by matrix multiplication circuitry 118, matrix multiplication circuitry 118 is able to perform matrix multiplication operations during the prefill stages of the layers 238 of the LLM that use such matrices. Likewise, once example processor 200 has modified the dimensions of the matrices within the matrix multiplication operations of the decoding stage for each layer 238 of the LLM, example processor 200 produces matrices for each layer 238 of the LLM that each have respective prefill stage hardware-optimized matrix dimensions 236 for their corresponding layer 238. Due to these matrices having such decoding stage hardware-optimized matrix dimensions 236 based on matrix dimensions 124 supported by matrix multiplication circuitry 118, matrix multiplication circuitry 118 is able to perform matrix multiplication operations during the decoding stages of all the layers 238 of the LLM that use such matrices. Example processor 200 then recompiles the LLM with the padded matrices (e.g., matrices having prefill stage hardware-optimized matrix dimensions 234 or decoding stage hardware-optimized matrix dimensions 236) to produce a hardware-optimized LLM 116 and stores the hardware-optimized LLM 116, for example, in memory 106. Example processor 200 then implements the hardware-optimized LLM 116 each time the LLM used to generate the hardware-optimized LLM 116 is required by an application 108.

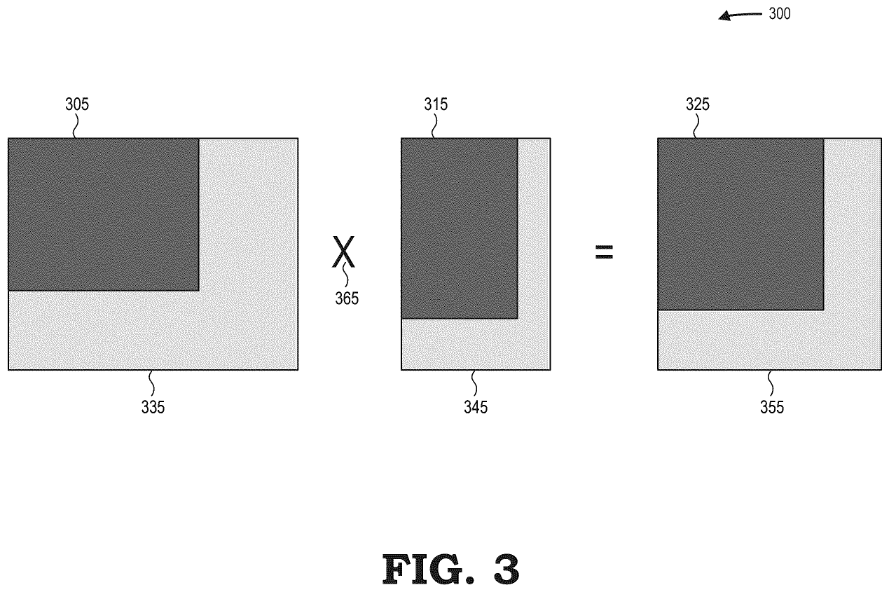

Referring now to FIG. 3, an example set of matrices 300 used in a matrix multiplication operation is presented, according to implementations. In implementations, the example set of matrices 300 includes a first matrix 305 (represented by darker shading in FIG. 3) on a first side (e.g., left side) of a multiplication operand 365, a second matrix represented by darker shading in FIG. 3) 315 on a second side (e.g., right side) of a multiplication operand 365, and a third matrix 325 represented by darker shading in FIG. 3) resulting from the multiplication of the first matrix 305 by the second matrix 315. In implementations, example processor 200 is configured to modify each matrix 305, 315, 325 such that each matrix is the same size as a corresponding set of matrix dimensions 124 supported by matrix multiplication circuitry 118. For example, in some implementations, example processor 200 is configured to modify each matrix 305, 315, 325 such that each matrix is a multiple of a corresponding set of matrix dimensions 124 representing a respective greatest common divisor of the dimensions of the matrices used during the matrix multiplication operations of the prefill stage or decoding stage of one or more layers 238 of an LLM. Further, in other implementations, example processor 200 is configured to modify each matrix 305, 315, 325 such that each matrix is the same size as a corresponding set of matrix dimensions 124 closest in size to the matrices used during the matrix multiplication operations of the prefill stage or decoding stage of a corresponding layer 238 of an LLM.

Referring to the example implementation presented in FIG. 3, example processor 200 is configured to modify the dimensions of the first matrix 305 by, for example, padding (e.g., adding one or more set values of 0 to) the first matrix 305 such that the first matrix 305 is equal in size to a first set of matrix dimensions 335 (e.g., represented by lighter shading in FIG. 3). The first set of matrix dimensions 335, for example, in some implementations, represents matrix dimensions that are a multiple of a set of matrix dimensions 124 closest in value to the greatest common divisor of the dimensions of first matrix 305. In other implementations, the first set of matrix dimensions 335 represents matrix dimensions that are the same size as a set of matrix dimensions 124 closest in value to the dimensions of the first matrix 305. Further, example processor 200 is configured to modify the dimensions of the second matrix 315 by, for example, padding the second matrix 315 such that the second matrix 315 is equal in size to a second set of matrix dimensions 345 (e.g., represented by lighter shading in FIG. 3). The second set of matrix dimensions 345, in some implementations, represents matrix dimensions that are a multiple of a set of matrix dimensions 124 closest in value to the greatest common divisor of the dimensions of second matrix 315. According to other implementations, the second set of matrix dimensions 345 represents matrix dimensions that are the same size as a set of matrix dimensions 124 closest in value to the dimensions of the second matrix 315. Additionally, example processor 200 is likewise configured to modify the dimensions of the third matrix 325 by, for example, padding the third matrix 325 such that the third matrix 325 is equal in size to a third set of matrix dimensions 355 (e.g., represented by lighter shading in FIG. 3). The third set of matrix dimensions 355, according to some implementations, represents matrix dimensions that are a multiple of a set of matrix dimensions 124 closest in value to the greatest common divisor of the dimensions of third matrix 315. In other implementations, the third set of matrix dimensions 355 represents matrix dimensions that are the same size as a set of matrix dimensions 124 closest in value to the dimensions of the third matrix 325.

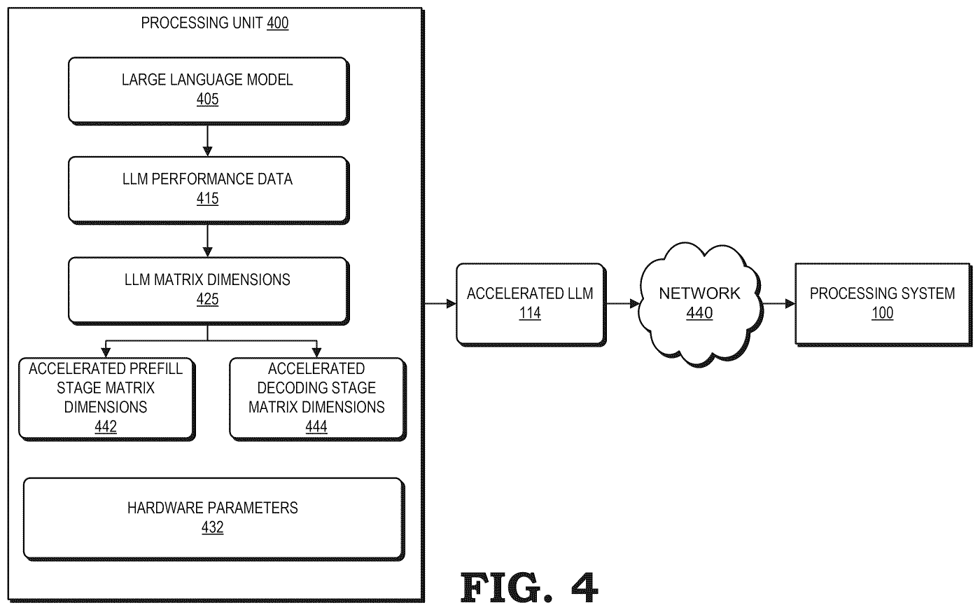

Referring now to FIG. 4, an example processing device 400 configured to generate an accelerated LLM 114 is presented, in accordance with implementations. In implementations, example processing device 400 includes a server, database, computer, laptop computer, or the like and is included in or otherwise connected to processing system 100. For example, in implementations, processing device 400 is connected to processing system 100 via a network 440. Such a network 440, for example, includes a local area network, wide area network, the Internet, wireless networks, wired networks, ethernet, data fabric networks, or any combination thereof, to name a few. According to implementations, processing device 400 is configured to modify an LLM 405 based on one or more hardware parameters 432 so as to generate an accelerated LLM 114. An LLM 405, for example, includes neural networks configured to generate one or more words, sentences, phrases, and the like based on one or more inputs (e.g., prompts). As an example, LLM 405 includes LLaMA, LLaMA2, Alpaca, Vicuna, Guanaco, RedPajama, Falcon, FLAN-T5, MPT, and the like. Such hardware parameters 432, for example, include data representing the sets of predetermined matrix dimensions supported by certain hardware such as certain AUs, CPUs, processors, processing systems, and the like. That is to say, the matrix dimensions able to be used in matrix multiplication operations performed by certain hardware. In some implementations, hardware parameters 432 represents sets of predetermined matrix dimensions supported by 2 or more different pieces of hardware (e.g., two or more different AUs).

To modify an LLM 405 based on hardware parameters 432, processing device 400 is configured to first initialize the LLM 405 and insert one or more observers into the LLM 405. These observers, for example, are configured to track the statistics of one or more tensors of the LLM 405 while the LLM 405 is executed. For example, the observers track the statistics (e.g., inputs, outputs) of matrix multiplication operations (e.g., MatMul primitives) of the LLM 405, represented in FIG. 4 as LLM performance data 415. After the observers capture LLM performance data 415, processing device 400 determines the dimensions of the matrices used during the matrix multiplication operations of the prefill phases of each layer 238 of LLM 405 and the decode phases of each layer 238 of LLM 405 based on LLM performance data 415. For example, based on LLM performance data 415, processing device 400 extracts the weights (e.g., weight shapes) applied to the parameters of each layer 238 of the LLM 405. Using the extracted weight shapes, processing device 400 runs one or more inferences (e.g., trained machine-learning models) configured to determine the dimensions of the matrices used in both the prefill stages and decoding stages of each layer of LLM 405. As an example, processing device 400 determines the dimensions of the first matrices (e.g., first matrices 305) used in matrix multiplication operations of the prefill and decoding stages of each layer 238 of LLM 405, the dimensions of the second matrices (e.g., second matrices 315) used in matrix multiplication operations of the prefill and decoding stages of each layer 238 of LLM 405, and the dimensions of the third matrices (e.g., third matrices 325) used in matrix multiplication operations of the prefill and decoding stages of each layer 238 of LLM 405. Referring to FIG. 4, the dimensions of the matrices used in the matrix multiplication operations of the prefill stages and decoding stages of each layer of LLM 405 are represented as LLM matrix dimensions 425.

After determining LLM matrix dimensions 425, processing device 400 is configured to modify the LLM matrix dimension 425 based on hardware parameters 432. According to implementations, processing device 400 modifies LLM matrix dimensions 425 of the first, second, and third matrices used in the matrix multiplication operations of the prefill stages and decoding stages of each layer of LLM 405 such that the LLM matrix dimensions 425 of the first, second, and third matrices used in the matrix multiplication operations of the prefill stages and decoding stages of each layer of LLM 405 are the same size as corresponding set of matrix dimensions represented by hardware parameters 432. For example, processing system 400 pads the LLM matrix dimensions 425 of the first, second, and third matrices used in the matrix multiplication operations of the prefill stages and decoding stages of each layer of LLM 405 such that the LLM matrix dimensions 425 of the first, second, and third matrices used in the matrix multiplication operations of the prefill stages and decoding stages of each layer of LLM 405 are equal in size to a corresponding set of matrix dimensions in hardware parameters 432 that are closest, yet greater, in size. Referring to the example implementation presented in FIG. 4, the modified LLM matrix dimensions 425 of the first, second, and third matrices used in the matrix multiplication operations of the prefill stages of each layer of LLM 405 are represented as prefill stage matrix dimensions 226 and the modified LLM matrix dimensions 425 of the first, second, and third matrices used in the matrix multiplication operations of the decoding stages of each layer of LLM 405 are represented as accelerated decoding stage matrix dimensions 228.

Once processing device 400 has determined prefill stage matrix dimensions 226 and accelerated decoding stage matrix dimensions 228 for one or more layers 238 of LLM 405, processing device 400 recompiles LLM 405 using prefill stage matrix dimensions 226 and accelerated decoding stage matrix dimensions 228 for the matrix multiplication operations of LLM 405 to produce accelerated LLM 114. Processing device 400 then transmits, via network 440, accelerated LLM 114, LLM execution data 120, or both to processing system 100. In this way, processing device 400 generates accelerated LLMs 114 that include matrix multiplication operations having matrix dimensions based on one or more hardware parameters 432. Due to the matrix dimensions of the matrix multiplication operations of the accelerated LLMs 114 being based on such hardware parameters 432, the likelihood that the matrix multiplication operations are able to be performed on the certain hardware represented by hardware parameters 432 is increased.

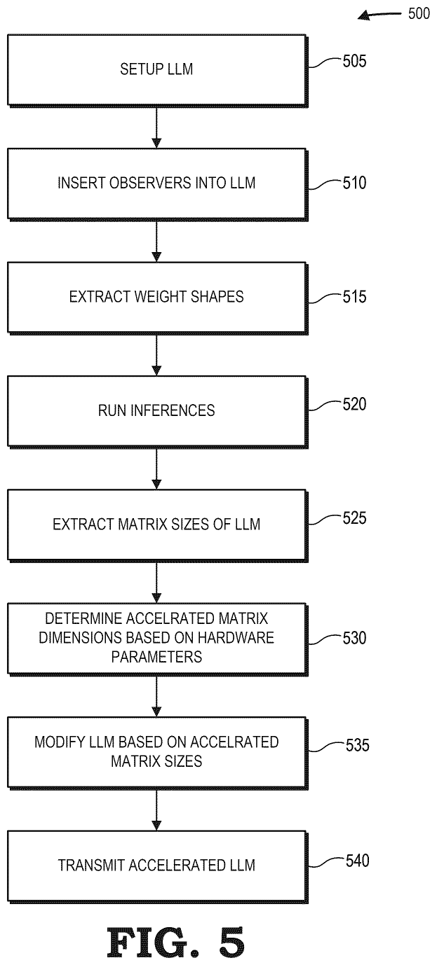

Referring now to FIG. 5, an example method 500 for modifying an LLM to produce an accelerated LLM based on one or more hardware parameters is presented, in accordance with some implementations. According to implementations, example method 500 is implemented by processing device 400. In implementations, example method 500, at block 505, includes processing device 400 initialize an LLM 405. That is to say, block 505 includes processing device 400 preparing an LLM 405 for execution. At block 510, processing device 400 is configured to insert one or more observers into the LLM 405. These observers each include code configured to track LLM performance data 415 while the LLM 405 is being executed. That is to say, the observers track statistics of the tensors (e.g., matrix multiplication operations) of the LLM 405 while the LLM 405 is being executed. At block 515, processing device 400 is configured to extract one or more weight shapes based on the LLM performance data 415. Such weight shapes, for example, represent the weights (e.g., parameters) applied to the values at each layer of the LLM 405. After extracting the weight shapes, at block 520, processing device 400 is configured to implement one or more inferences so as to determine the dimensions of the matrices used in matrix multiplication operations of the LLM 405. Such inferences, for example, include one or more trained machine-learning models configured to determine the dimensions of the matrices (e.g., first matrices, second matrices, third matrices) used in the matrix multiplication operations of the prefill and decoding stages of each layer 238 of the LLM 405 based on, for example, the extracted weight shapes, inputs fed to the LLM 405, outputs produced by the LLM 405, or any combination thereof.

As block 525, processing device 400 is configured to extract the dimensions of the matrices (e.g., first matrices, second matrices, third matrices) used in the matrix multiplication operations of the prefill and decoding stages of each layer 238 of the LLM 405 based on the inferences. For example, based on one or more outputs of the inferences, processing device 400 determines the dimensions of the matrices used in the matrix multiplication operations of the prefill and decoding stages of each layer 238 of the LLM 405. At block 530, processing device 400 generates accelerated matrix dimensions (e.g., accelerated prefill stage matrix dimensions 442, accelerated decoding stage matrix dimensions 444) based on one or more hardware parameters 432. For example, processing device 400 modifies the determined dimensions of the matrices used in the matrix multiplication operations of the prefill and decoding stages of each layer 238 of the LLM 405 so as to be the same size as a corresponding set of matrix dimensions represented by one or more hardware parameters 432. After determining the accelerated matrix dimensions, at block 535, processing device 400 is configured to modify the matrix multiplication operations of the LLM 405 so as to include the determined accelerated matrix dimensions rather than the matrix dimensions of the LLM 405 determined at block 525. At block 540, processing device 400 then recompiled the LLM 405 using the modified matrix multiplication operations so as to produce an accelerated LLM 114.

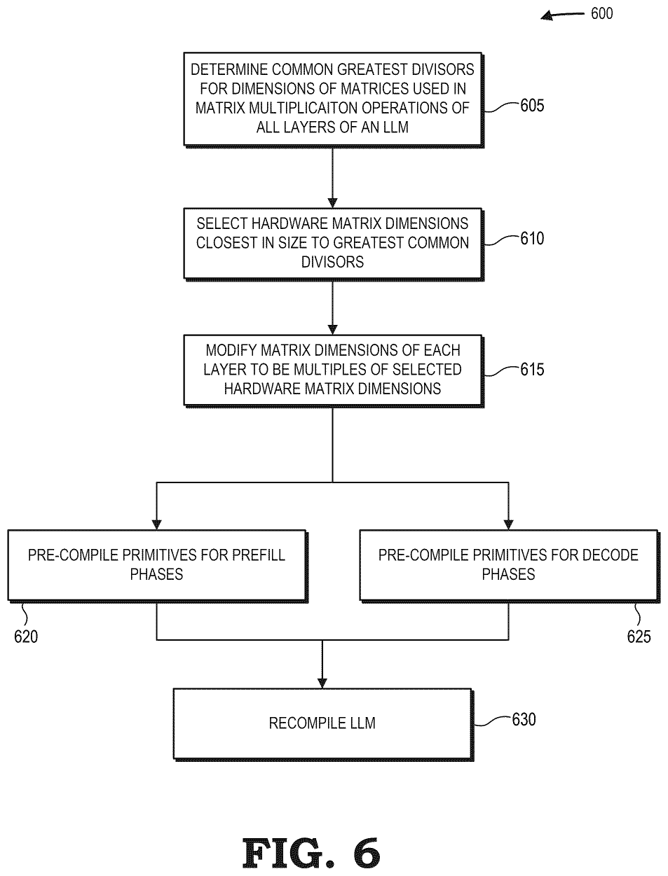

Referring now to FIG. 6, an example method 600 for modifying an LLM to produce a hardware-optimized LLM based on greatest common divisors is presented, in accordance with some implementations. According to implementations, example method 600 is implemented in processing system 100 by CPU 102. In implementations, at block 605 of example method 600, CPU 102 determines the dimensions of the matrices (e.g., first matrices, second matrices, third matrices) used in the matrix multiplication operations of the prefill stages and decoding stages of every layer 238 of an LLM. That is to say, CPU 102 determines the prefill stage matrix dimensions 226 and decoding stage matrix dimensions 228 of every layer 238 of an LLM. CPU 102 then determines a first greatest common divisor for the dimensions of the first matrices (e.g., matrices on the left of the operand) used in matrix multiplication operations in the prefill stage of every layer 238 of the LLM, a second greatest common divisor for the dimensions of the second matrices (e.g., matrices on the right of the operand) used in matrix multiplication operations in the prefill stage of every layer 238 of the LLM, a third greatest common divisor for the dimensions of the third matrices (e.g., resulting matrices) used in matrix multiplication operations in the prefill stage of every layer 238 of the LLM, a fourth greatest common divisor for the dimensions of the first matrices used in matrix multiplication operations in the decoding stage of every layer 238 of the LLM, a fifth greatest common divisor for the dimensions of the second matrices used in matrix multiplication operations in the decoding stage of every layer 238 of the LLM, and a sixth greatest common divisor for the dimensions of the third matrices used in matrix multiplication operations in the decoding stage of every layer 238 of the LLM. Such greatest common divisors, for example, represent the greatest set of matrix dimensions by which the dimensions of two or more matrices are able to be divided with no remainder.

After determining the greatest common divisors, at block 610, CPU 102 is configured to select corresponding sets of predetermined matrix dimensions 124 supported by matrix multiplication circuitry 118 closest in size, but greater than, each greatest common divisor. As an example, CPU 102 selects a first set matrix dimensions 124 closest in size, but greater than, the first greatest common divisor, a second set matrix dimensions 124 closest in size, but greater than, the second greatest common divisor, a third set matrix dimensions 124 closest in size, but greater than, the third greatest common divisor, a fourth set matrix dimensions 124 closest in size, but greater than, the fourth greatest common divisor, a fifth set matrix dimensions 124 closest in size, but greater than, the fifth greatest common divisor, and a sixth set matrix dimensions 124 closest in size, but greater than, the sixth greatest common divisor. Once CPU 102 has selected corresponding sets of predetermined matrix dimensions 124 supported by matrix multiplication circuitry 118 closest in size, but greater than, each greatest common divisor, at block 615, CPU 102 modifies the dimensions of the first, second, and third matrices used in matrix multiplication operations of the prefill stages and decoding stages of every layer 238 of the LLM such that the dimensions of these first, second, and third matrices are multiples of a corresponding select set of matrix dimensions 124. As an example, CPU 102 modifies the first, second, and third matrices used in matrix multiplication operations of the prefill stages of every layer 238 of the LLM to be multiples of the selected first, second, and third sets of predetermined matrix dimensions 124, respectively, to produce prefill stage hardware-optimized matrix dimensions 234. Likewise, CPU 102 modifies the first, second, and third matrices used in matrix multiplication operations of the decoding stages of every layer 238 of the LLM to be multiples of the selected fourth, fifth, and sixth sets of predetermined matrix dimensions 124, respectively, to produce decoding stage hardware-optimized matrix dimensions 236.

At block 620, CPU 102 then pre-compiles one or more primitives for the prefill stages of every layer 238 of the LLM. Such primitives, for example, represent matrix multiplication operations using first, second, and third matrices having prefill stage hardware-optimized matrix dimensions 234. Further at block 625, CPU 102 pre-compiles one or more primitives for the decoding stages of every layer 238 of the LLM. Such primitives, for example, represent matrix multiplication operations using first, second, and third matrices having decoding stage hardware-optimized matrix dimensions 236. After pre-compiling the primitives at blocks 620 and 625, CPU 102, at block 630, recompiles the LLM using the pre-compiled primitives to produce a hardware-optimized LLM 116 (e.g., a recompiled LLM).

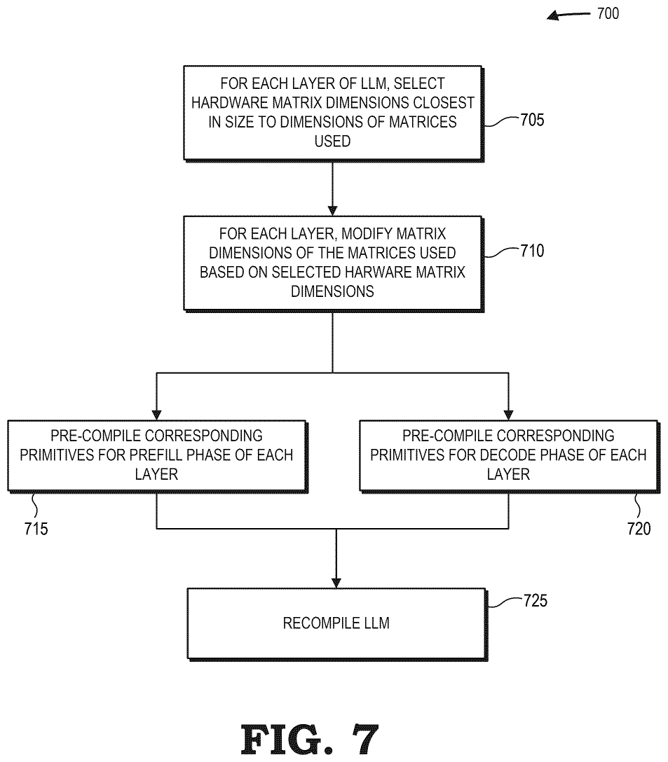

Referring now to FIG. 7, an example method 700 for modifying an LLM to produce a hardware-optimized LLM based on hardware-supported matrix dimensions is presented, in accordance with some implementations. According to implementations, example method 700 is implemented in processing system 100 by CPU 102. In implementations, at block 705 of example method 700, CPU 102 determines the dimensions of the matrices (e.g., first matrices, second matrices, third matrices) used in the matrix multiplication operations of the prefill stages and decoding stages for each layer 238 of an LLM. That is to say, CPU 102 determines the prefill stage matrix dimensions 226 and decoding stage matrix dimensions 228 of each layer 238 of an LLM. Further, at block 705, for each layer 238 of the LLM, CPU 102 selects corresponding sets of predetermined matrix dimensions 124 supported by matrix multiplication circuitry 118 based on the dimensions of the first, second, and third matrices used in matrix multiplication operations for the prefill stage and decoding stage of the layer 238. For example, CPU 102 selects a first set of matrix dimensions 124 closest, but greater, in size that the dimensions of the first matrices (e.g., matrices to the left of the operand) used in the matrix multiplication operations of the prefill stage of the layer 238, a second set of matrix dimensions 124 closest, but greater, in size that the dimensions of the second matrices (e.g., matrices to the right of the operand) used in the matrix multiplication operations of the prefill stage of the layer 238, a third set of matrix dimensions 124 closest, but greater, in size that the dimensions of the third matrices (e.g., resulting matrices) used in the matrix multiplication operations of the prefill stage of the layer 238, a fourth set of matrix dimensions 124 closest, but greater, in size that the dimensions of the first matrices used in the matrix multiplication operations of the decoding stage of the layer 238, a fifth set of matrix dimensions 124 closest, but greater, in size that the dimensions of the second matrices used in the matrix multiplication operations of the decoding stage of the layer 238, and a sixth set of matrix dimensions 124 closest, but greater, in size that the dimensions of the third matrices used in the matrix multiplication operations of the decoding stage of the layer 238.

After selecting sets of predetermined matrix dimensions 124 for a layer 238 of the LLM, at block 710, CPU 102 is configured to modify the dimensions of the matrices (e.g. first, second, third matrices) of the matrix multiplication operations of the prefill and decoding stages of the layer 238 such that the dimensions of these matrices are equal in value to corresponding selected sets of predetermined matrix dimensions 124. As an example, CPU 102 modifies the dimensions of first matrices used in matrix multiplication operations of the prefill stage of the layer 238 to be equal to a first set of matrix dimensions 124, the dimensions of second matrices used in matrix multiplication operations of the prefill stage of the layer 238 to be equal to a second set of matrix dimensions 124, the dimensions of third matrices used in matrix multiplication operations of the prefill stage of the layer 238 to be equal to a third set of matrix dimensions 124 to produce a set of prefill stage hardware-optimized matrix dimensions 234 for the layer 238. Additionally, CPU 102 modifies the dimensions of first matrices used in matrix multiplication operations of the decoding stage of the layer 238 to be equal to a fourth set of matrix dimensions 124, the dimensions of second matrices used in matrix multiplication operations of the decoding stage of the layer 238 to be equal to a fifth set of matrix dimensions 124, and the dimensions of third matrices used in matrix multiplication operations of the decoding stage of the layer 238 to be equal to a sixth set of matrix dimensions 124 to produce a set of decoding stage hardware-optimized matrix dimensions 234 for the layer 238.

After modifying the dimensions of the matrices used in the matrix multiplication operations of the prefill stage of the layer 238, at block 715, CPU 102 then pre-compiles one or more primitives for the prefill stage of the layer 238. Such primitives, for example, represent matrix multiplication operations using first, second, and third matrices having prefill stage hardware-optimized matrix dimensions 234. Further at block 720, CPU 102 pre-compiles one or more primitives for the decoding stages of the layer 238. Such primitives, for example, represent matrix multiplication operations using first, second, and third matrices having decoding stage hardware-optimized matrix dimensions 236. After pre-compiling primitives at blocks 620 and 625 for each layer 238 of the LLM, CPU 102, at block 725, recompiles the LLM using the pre-compiled primitives to produce a hardware-optimized LLM 116 (e.g., recompiled LLM).

In some implementations, the apparatus and techniques described above are implemented in a system including one or more integrated circuit (IC) devices (also referred to as integrated circuit packages or microchips), such as the AU described above with reference to FIGS. 1-7. Electronic design automation (EDA) and computer aided design (CAD) software tools may be used in the design and fabrication of these IC devices. These design tools typically are represented as one or more software programs. The one or more software programs include code executable by a computer system to manipulate the computer system to operate on code representative of circuitry of one or more IC devices so as to perform at least a portion of a process to design or adapt a manufacturing system to fabricate the circuitry. This code can include instructions, data, or a combination of instructions and data. The software instructions representing a design tool or fabrication tool typically are stored in a computer readable storage medium accessible to the computing system. Likewise, the code representative of one or more phases of the design or fabrication of an IC device may be stored in and accessed from the same computer readable storage medium or a different computer readable storage medium.

A computer readable storage medium may include any non-transitory storage medium, or combination of non-transitory storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory) or coupled to the computer system via a wired or wireless network (e.g., network accessible storage (NAS)).

In some implementations, certain aspects of the techniques described above may be implemented by one or more processors of a processing system executing software. The software includes one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

Note that not all of the activities or elements described above in the general description are required, that a portion of a specific activity or device may not be required, and that one or more further activities may be performed, or elements included, in addition to those described. Still further, the order in which activities are listed is not necessarily the order in which they are performed. Also, the concepts have been described with reference to specific implementations. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific implementations. However, the benefits, advantages, solutions to problems, and any feature(s) that may cause any benefit, advantage, or solution to occur or become more pronounced are not to be construed as a critical, required, or essential feature of any or all the claims. Moreover, the particular implementations disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular implementations disclosed above may be altered or modified and all such variations are considered within the scope of the disclosed subject matter. Accordingly, the protection sought herein is as set forth in the claims below.

What is claimed is:

1. A processing system, comprising:
an accelerator unit (AU) configured to perform matrix multiplication using sets of predetermined matrix dimensions; and
a processor configured to:
modify a first matrix multiplication operation of a large language model (LLM) based on the sets of predetermined matrix dimensions supported by the AU; and
recompile the LLM based on the modified first matrix multiplication operation.

2. The processing system of claim 1, wherein the AU is configured to:
perform the modified first matrix multiplication operation of the recompiled LLM.

3. The processing system of claim 1, wherein the processor is further configured to:
select a set of predetermined matrix dimensions of the sets of predetermined matrix dimensions based on dimensions of a matrix used in the matrix multiplication operation of the LLM; and
modify the dimensions of the matrix used in the first matrix multiplication operation based on the set of predetermined matrix dimensions.

4. The processing system of claim 1, wherein the processor is configured to:
modify a second matrix multiplication operation of the LLM based on the sets of predetermined matrix dimensions supported by the AU, wherein the first matrix multiplication operation is associated with a prefill phase of the LLM and the second matrix multiplication operation is associated with a decoding phase of the LLM.

5. The processing system of claim 1, wherein the processor is configured to:
store the recompiled LLM in a memory; and
implement the recompiled LLM from the memory.

6. The processing system of claim 1, wherein the processor is configured to:
determine a greatest common divisor of dimensions of matrices used in a prefill phase of the LLM; and
select a set of predetermined matrix dimensions of the sets of predetermined matrix dimensions based on the greatest common divisor.

7. The processing system of claim 6, wherein the processor is configured to:
modify the dimensions of matrices used in the prefill phase of the LLM based on the selected set of predetermined matrix dimensions.

8. A method, comprising:
modifying a first matrix multiplication operation of a large language model (LLM) based on sets of predetermined matrix dimensions supported by an accelerator unit (AU); and
recompiling the LLM based on the modified first matrix multiplication operation.

9. The method of claim 8, further comprising:
performing, at the AU, the modified first matrix multiplication operation of the recompiled LLM.

10. The method of claim 8, wherein modifying the first matrix multiplication operation comprises:
selecting a set of predetermined matrix dimensions of the sets of predetermined matrix dimensions based on dimensions of a matrix used in the matrix multiplication operation of the LLM; and
modifying the dimensions of the matrix used in the first matrix multiplication operation based on the set of predetermined matrix dimensions.

11. The method of claim 8, further comprising:
modifying a second matrix multiplication operation of the LLM based on the sets of predetermined matrix dimensions supported by the AU, wherein the first matrix multiplication operation is associated with a prefill phase of the LLM and the second matrix multiplication operation is associated with a decoding phase of the LLM.

12. The method of claim 8, further comprising
storing the recompiled LLM in a memory; and
implementing the recompiled LLM from the memory.

13. The method of claim 8, wherein modifying the first matrix multiplication operation comprises:
determining a greatest common divisor of dimensions of matrices used in a decoding phase of the LLM; and
selecting a set of predetermined matrix dimensions of the sets of predetermined matrix dimensions supported by the AU based on the greatest common divisor.

14. The method of claim 13, wherein modifying the first matrix multiplication operation comprises:
modifying the dimensions of matrices used in the decoding phase of the LLM based on the set of predetermined matrix dimensions.

15. A processing system, comprising:
an accelerator unit (AU) configured to perform matrix multiplication using sets of predetermined matrix dimensions; and
a processor configured to:
implement a large language model (LLM) including a plurality of layers; and
for each layer of the plurality of layers, modify a first matrix multiplication operation of a prefill phase of the layer based on the sets of predetermined matrix dimensions and modify a second matrix multiplication operation of a decode phase of the layer based on the sets of predetermined matrix dimensions supported by the AU.

16. The processing system of claim 15, wherein the AU is configured to:
recompile the LLM based on the modified first matrix multiplication operation and modified second matrix multiplication operation of each layer of the plurality of layers.

17. The processing system of claim 15, wherein the processor is further configured to:
select a first set of predetermined matrix dimensions of the sets of predetermined matrix dimensions supported by the AU of a first matrix used in the first matrix multiplication operation of the LLM; and
modify the dimensions of the first matrix used in the first matrix multiplication operation based on the first set of predetermined matrix dimensions.

18. The processing system of claim 17, wherein the processor is configured to:
select a second set of predetermined matrix dimensions of the sets of predetermined matrix dimensions supported by the AU of a second matrix used in the second matrix multiplication operation of the LLM; and
modify the dimensions of the second matrix used in the second matrix multiplication operation based on the second set of predetermined matrix dimensions.

19. The processing system of claim 15, wherein the modified first matrix multiplication operation of a first layer of the plurality of layers is different from the modified first matrix multiplication operation of a second layer of the plurality of layers.

20. The processing system of claim 15, wherein, for each layer of the plurality of layers, the first matrix multiplication operation is different from the second matrix multiplication operation.
